(19) United States
(12) Patent Application Publication
(10) Pub. No.: US 2026/0234973 A1
(43) Pub. Date: Aug. 13, 2026

(54) REINFORCING HINGE PLATE AND METHOD OF RETROFITTING A HINGE

(71) Applicant: RH US, LLC, Corte Madera, CA (US)

(72) Inventors: Edgar Blazona, Orinda, CA (US); Philip le Roux, Berkeley, CA (US)

(21) Appl. No.: 19/053,242

(22) Filed: Feb. 13, 2025

(51) Int. Cl. E05D 5/02

(52) U.S. Cl. CPC E05D 5/0215; E05Y 2900/20

(57) ABSTRACT

A reinforcing plate for a hinge. The reinforcing plate includes a body having a first tab, a second tab connected to the first tab and spaced apart from the first tab, a first opening in the first tab, a second opening in the second tab, a first recess in the first tab, a second recess in the second tab, and at least one pressure concentration surface at at least one of the first tab or the second tab.

### BACKGROUND

### 1. Field

The present disclosure relates to hinges.

### 2. Description of the Related Art

A variety of different types of hinges exist, including concealed hinges, semi-concealed hinges, surface mounted hinges, wrap hinges, butt hinges, Youngdale hinges, pivot or knife hinges, and demountable hinges. The suitability of these hinges may depend on their application, the desired functionality, and the anticipated loads. However, some conventional hinges, such as European-style hinges, may not be suitable for carrying heavier loads, such as securing heavier doors to a cabinet frame.

The above-described information disclosed in this section is only for improving the understanding of the background of the present disclosure and thus it may include information that does not constitute prior art.

### SUMMARY

The present disclosure relates to various embodiments of a reinforcing plate for a hinge. In one embodiment, the reinforcing plate includes a body including a first tab; a second tab connected to the first tab and spaced apart from the first tab; a first opening in the first tab; a second opening in the second tab; a first recess in the first tab; a second recess in the second tab; and at least one pressure concentration surface at at least one of the first tab or the second tab.

The at least one pressure concentration surface may include a first pair of pressure concentration surfaces on opposite sides of the first opening.

The at least one pressure concentration surface may further include a second pair of pressure concentration surfaces on opposite sides of the second opening.

Each of the first tab and the second tab may further include an upper wall; a lower wall; and an outer sidewall.

The first pair of pressure concentration surfaces may include one pressure concentration surface in the first recess of the first tab; and another pressure concentration surface on the lower wall of the first tab.

The second pair of pressure concentration surfaces may include one pressure concentration surface in the second recess of the second tab; and another pressure concentration surface on the lower wall of the second tab.

Edges of the first and second recesses facing each other may be open.

The body of the reinforcing plate may be C-shaped.

The present disclosure also relates to various embodiments of a hinge assembly. In one embodiment, the hinge assembly includes a hinge including a cabinet mounting plate; a cup mounting plate; a hinge arm rotatably coupled to the cup plate with a pin; and a quick-release mechanism coupled to the hinge arm and configured to attach and detach from the cabinet mounting plate. The hinge assembly also includes a reinforcing plate including a body including a first tab; a second tab connected to the first tab and spaced apart from the first tab; a first opening in the first tab; a second opening in the second tab; a first recess in the first tab; a second recess in the second tab; and at least one pressure concentration surface at at least one of the first tab or the second tab. When the reinforcing plate is coupled to the hinge, the cup mounting plate of the hinge is accommodated in the first recess and the second recess of the reinforcing plate and the at least one pressure concentration surface contacts a portion of the cup mounting plate in at least one of the first recess or the second recess.

The present disclosure also relates to various methods of retrofitting a hinge to support a heavier load. In one embodiment, the method includes removing screws securing a cup mounting plate of the hinge to a cabinet door and attaching the reinforcing plate to the hinge and to the cabinet door with a plurality of screws.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIGS. 1A-1B are an exploded perspective view and an assembled perspective view, respectively, of a reinforcing hinge plate according to one embodiment of the present disclosure connected to a hinge;

FIGS. 2A-2D are a front perspective view, a rear perspective view, a cross-sectional view taken along line A-A, and a cross-sectional view taken along line B-B, respectively, of the reinforcing hinge plate of FIGS. 1A-1B; and

FIG. 3 is a flowchart illustrating tasks of a method of retrofitting a hinge to accommodate a heavier load according to one embodiment of the present disclosure.

### DETAILED DESCRIPTION

The present disclosure relates to various embodiments of a reinforcing plate for a hinge. The reinforcing plate is configured to strengthen the hinge such that the hinge can support a greater load, such as a heavier cabinet door, compared to a hinge without the reinforcing plate. Only a portion of the reinforcing plate is configured to contact the hinge and the cabinet door to which the hinge is attached. In one or more embodiments, the reinforcing plate includes relatively small contact surfaces (pressure concentration surfaces) that are configured to contact the hinge and the cabinet door. These relatively small contact surfaces may be on opposite sides of fasteners securing the reinforcing plate to the hinge (and securing the hinge to the cabinet door), and they are configured to increase the pressure applied by the reinforcing plate onto the hinge and to effectively shift the connection point between the hinge and the cabinet door toward a pivot pin of the hinge. In this manner, the reinforcing plate is configured to increase the load carrying capacity of the hinge. The present disclosure also relates to various embodiments of a method of retrofitting a hinge to support a heavier load by installing a reinforcing plate.

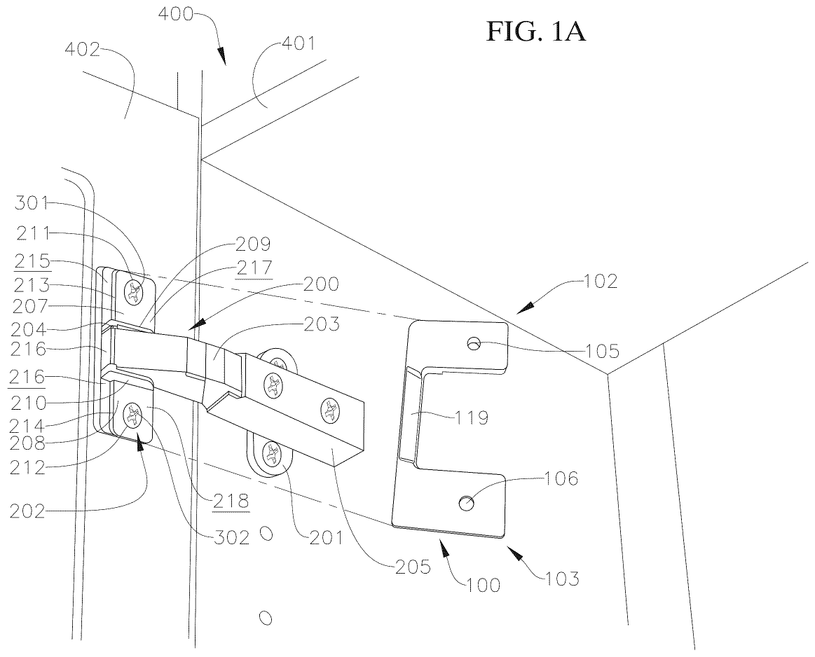

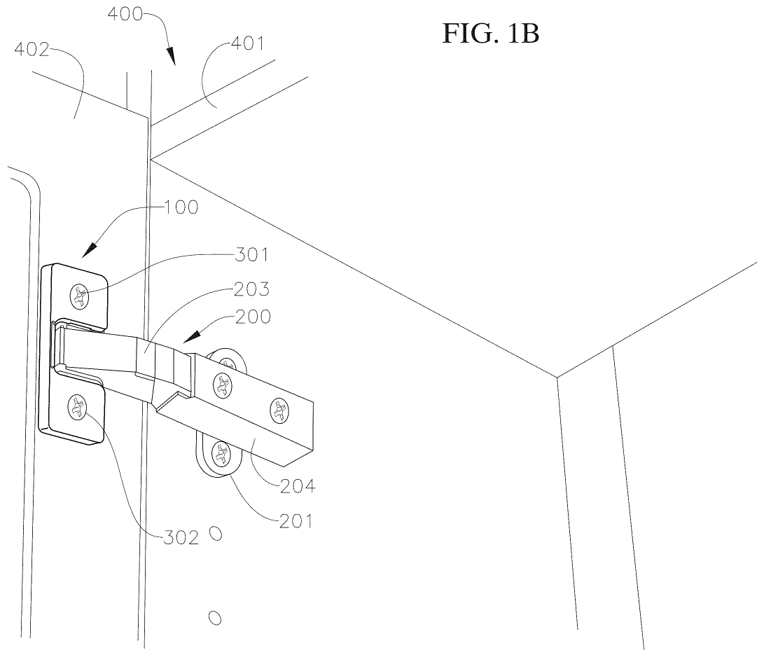

FIGS. 1A-1B depict a reinforcing plate 100 configured to increase the load carrying capacity of a hinge 200 according to one embodiment of the present disclosure. In the illustrated embodiment, the hinge 200 is a European-style hinge including a cabinet mounting plate 201 configured to be connected to a cabinet frame 401 of a cabinet 400, a cup plate 202 configured to be connected to a cabinet door 402 of the cabinet 400, a hinge arm 203 rotatably coupled to the cup plate 202 with a pin 204, and a quick-release mechanism 205 coupled to the hinge arm 203 and configured to attach and detach from the cabinet mounting plate 201. In one or more embodiments, the hinge 200 may include a damping mechanism such that the hinge 200 is configured to exhibit a soft-close feature. In one or more embodiments, the hinge 200 may be any other suitable type or kind of hinge.

In the illustrated embodiment, the cup plate 202 includes a cup 206, a pair of tabs 207, 208 on opposite sides of the cup 206, and a pair of reinforcing ribs 209, 210 on opposite sides of the cup 206 and along inner edges of the tabs 207, 208. Each of the tabs 207, 208 includes an opening 211, 212 (e.g., a countersunk hole), respectively, configured to accommodate a fastener (e.g., a screw) for securing the cup plate 202 to the cabinet door. Additionally, in the illustrated embodiment, each of the tabs 207, 208 of the cup plate 202 includes a step or transition 213, 214 between a lower surface 215, 216 and a higher surface 217, 218, respectively. In one or more embodiments, the steps 213, 214 extend parallel (or substantially parallel) to the lengthwise direction of the cup plate 202 (e.g., the steps 213, 214 extend parallel (or substantially parallel) to the pin 204). In the illustrated embodiment, the openings 211, 212 are located in the higher surfaces 217, 218 of the tabs 207, 208.

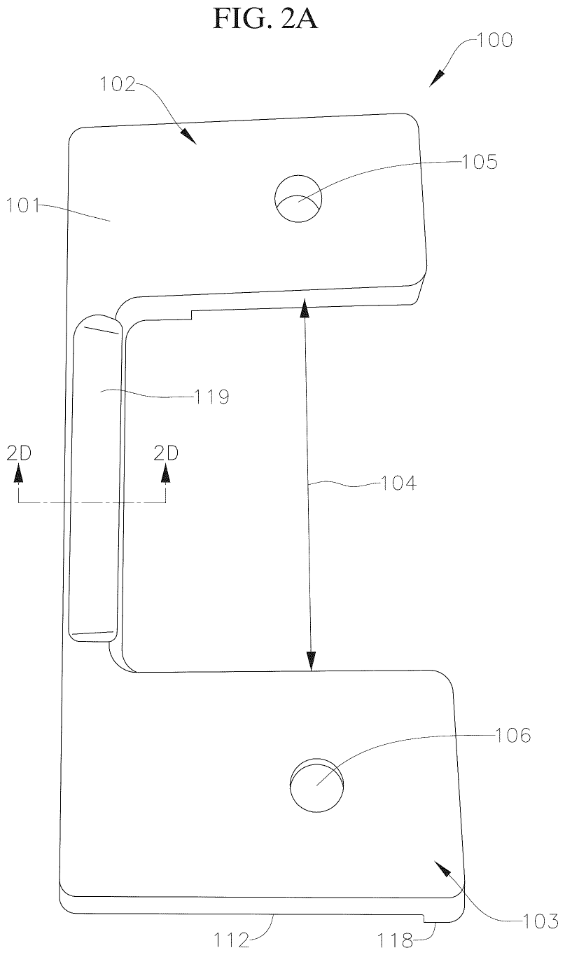

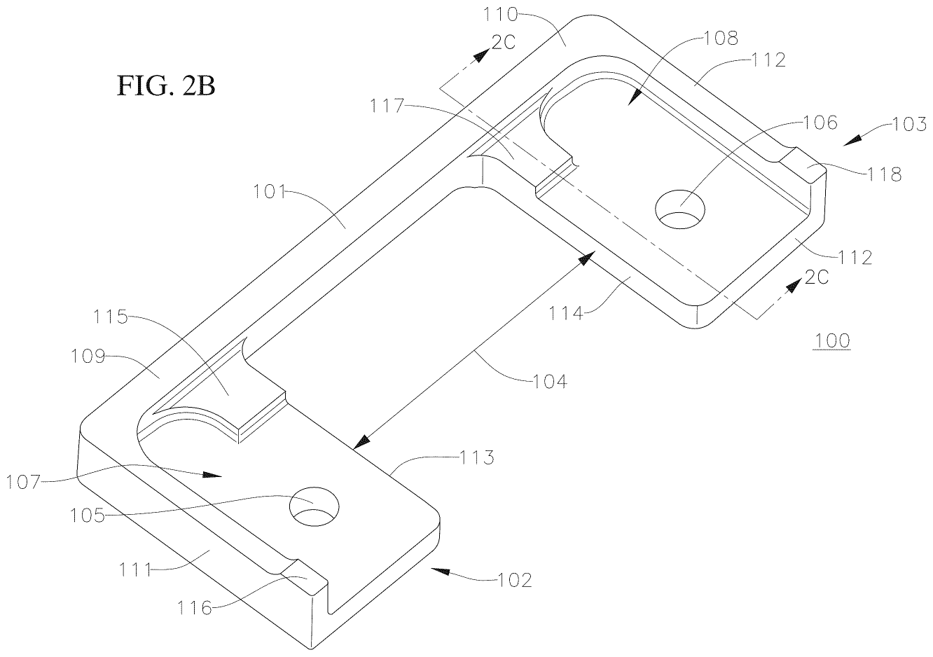

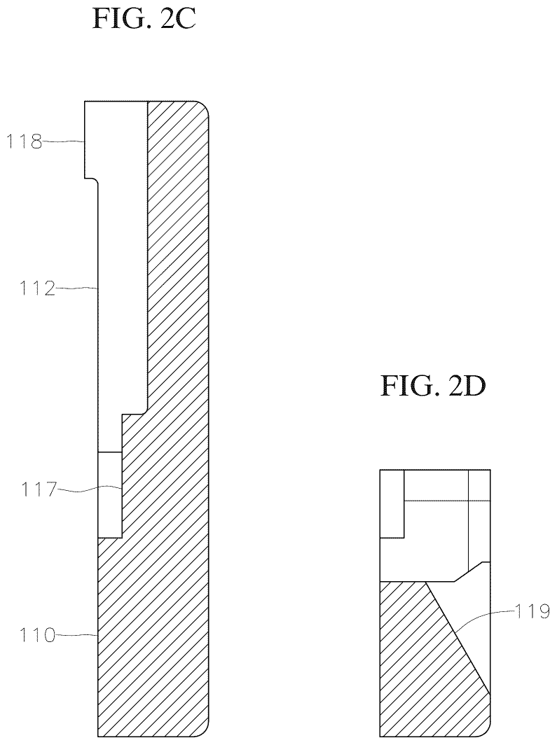

With reference now to FIGS. 2A-2D, the reinforcing plate 100 for the cabinet hinge 200 according to one embodiment of the present disclosure includes a body 101 having a pair of lobes or tabs 102, 103 (i.e., a first tab 102 and a second tab 103) that are connected to each other and spaced apart from each other by a gap 104 (e.g., an opening). In one or more embodiments, the body 101 may be generally C-shaped. Although in the illustrated embodiment each of the tabs 102, 103 is rectangular with rounded corners, in one or more embodiments the tabs 102, 103 may have any other suitable shape or shapes. In the illustrated embodiment, each of the tabs 102, 103 includes an opening 105, 106 (e.g., a hole), respectively, configured to accommodate a fastener (e.g., a screw) for securing the reinforcing plate 100 to the cabinet hinge and the cabinet door.

In the illustrated embodiment, each of the tabs 102, 103 includes a recess 107, 108, respectively, in the front face of the body 101. The recesses 107, 108 are each configured to accommodate a portion of the hinge 200. Additionally, in the illustrated embodiment, each of the recesses 107, 108 is surrounded on two sides by an upper wall 109, 110 and an outer sidewall 111, 112, respectively. Edges 113, 114 of the recesses 107, 108 facing each other and facing away from the upper wall 109, 110 are open (i.e., walls are not provided along edges 113, 114 of the recesses 107, 108 facing each other and facing away from the upper wall 109, 110).

Additionally, in one or more embodiments, the body 101 includes one or more pressure concentration surfaces. In the illustrated embodiment, the body 101 includes a pair of pressure concentration surfaces 115, 116 and 117, 118, respectively, on opposite sides of each of the openings 105, 106 (e.g., a first pair of pressure concentration surfaces 115, 116 on opposite sides of the opening 105 in the first tab 102 and a second pair of pressure concentration surfaces 117, 118 on opposite sides of the opening 106 in the second tab 103). In the illustrated embodiment, each tab 102, 103 includes a first pressure concentration surface 115, 117 in the recess 107, 108, respectively, and a second pressure concentration surface 116, 118 along the outer sidewall 111, 112, respectively. In the illustrated embodiment, each of the first pressure concentration surfaces 115, 117 is generally rectangular, in one or more embodiments, the first pressure concentration surfaces 115, 117 may have any other suitable shape, such as square or circular. Additionally, in the illustrated embodiment, the area of the first pressure concentration surface 115, 117 is smaller than the area of the recess 107, 108, respectively, and thus only a portion of the hinge 200 that is accommodated in the recesses 107, 108 is contacted by the reinforcing plate 100. In the illustrated embodiment, the portion of the body 101 between the first pressure concentration surface 115, 117 in the recess 107, 108 and the outer sidewall 111, 112 does not contact the hinge 200. Additionally, in one or more embodiments, only the second pressure concentration surfaces 116, 118 are configured to contact the cabinet door when the reinforcing plate 100 is installed (e.g., the upper walls 109, 110 and the portions of the outer sidewalls 111, 112 other than the second pressure concentration surfaces 116, 118 are configured not to contact the cabinet door when the reinforcing plate 100 is installed).

Additionally, in the embodiment illustrated in FIG. 2C, the reinforcing plate 100 also includes a chamfer 119 in the rear face of the body 101 along the portion of the body 101 between the tabs 102, 103. In one or more embodiments, the chamfer 119 may taper at an angle from approximately 45 degrees to approximately 75 degrees (e.g., the chamfer 119 may taper at an angle of approximately 60 degrees). In one or more embodiments, ends of the chamfer 119 in the lengthwise direction proximate to the tabs 102, 103 may be rounded. The chamfer 119 is configured to prevent the hinge 200 from contacting the reinforcing plate 100, which might otherwise prevent the hinge 200 from completely opening and/or may cause damage or premature wear to the hinge 200 and the reinforcing plate 100.

To attach the reinforcing plate 100 to the hinge 200, the reinforcing plate 100 is placed on top of the cup plate 202 of the hinge 200 and then fasteners (e.g., screws) 301, 302 are inserted through the aligned openings (e.g., holes) 105, 106 and 211, 212, respectively, in the reinforcing plate 100 and the cup plate 202 of the hinge 200. As the fasteners 301, 302 are tightened, the first pressure concentration surfaces 115, 117 in the recesses 107, 108 of the reinforcing plate 100 contact (engage) a portion of the lower surfaces 215, 216, respectively, of the cup plate 202 and the second pressure concentration surfaces 116, 118 engage a portion of the cabinet door 402. As described above, the first and second pressure concentration surfaces 115, 117 and 116, 118, which are on opposite sides of the fasteners 301, 302 securing the reinforcing plate 100 to the hinge 200 (and securing the hinge 200 to the cabinet door 402), are configured to increase the pressure applied by the reinforcing plate 100 onto the hinge 200 and to effectively shift the connection point between the hinge 200 and the cabinet door 402 toward the pivot pin 204 of the hinge 200. In this manner, the reinforcing plate 100 is configured to increase the load carrying capacity of the hinge 200.

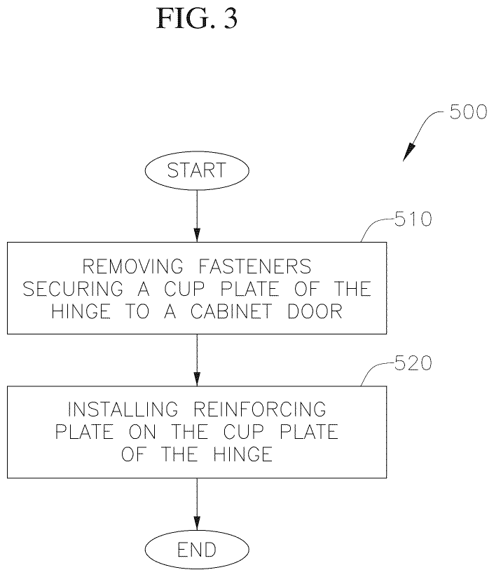

FIG. 3 depicts a method 500 of retrofitting a hinge to support a heavier load according to one embodiment of the present disclosure. In the illustrated embodiment, the method 500 includes a task 510 of removing fasteners (e.g., screws) securing a cup plate of the hinge to a cabinet door (i.e., the task 510 includes detaching the cabinet door from the hinge). In the illustrated embodiment, the method 500 also includes a task 520 of installing a reinforcing plate on the cup plate of the hinge. In one or more embodiments, the reinforcing plate may be the same as or similar to the reinforcing plate 100 described above with reference to FIGS. 1A-2B.

While this invention has been described in detail with particular references to exemplary embodiments thereof, the exemplary embodiments described herein are not intended to be exhaustive or to limit the scope of the invention to the exact forms disclosed. Moreover, although the hinge is described herein for use on a cabinet, one of skill in the art would appreciate that the features could be applied to other hinged components. Persons skilled in the art and technology to which this invention pertains will appreciate that alterations and changes in the described structures can be practiced without meaningfully departing from the principles, spirit, and scope of this invention, as set forth in the following claims. Additionally, as used herein, the term “substantially” and similar terms are used as terms of approximation and not as terms of degree, and are intended to account for the inherent deviations in measured or calculated values that would be recognized by those of ordinary skill in the art. Furthermore, as used herein, when a component is referred to as being “on” another component, it can be directly on the other component or components may also be present therebetween. Moreover, when a component is component is referred to as being “coupled” to another component, it can be directly attached to the other component or intervening components may be present therebetween.

What is claimed is:

1. A reinforcing plate for a hinge, the reinforcing plate comprising:
a body comprising:
a first tab;
a second tab connected to the first tab and spaced apart from the first tab;
a first opening in the first tab;
a second opening in the second tab;
a first recess in the first tab;
a second recess in the second tab; and
at least one pressure concentration surface at at least one of the first tab or the second tab.

2. The reinforcing plate of claim 1, wherein the at least one pressure concentration surface comprises a first pair of pressure concentration surfaces on opposite sides of the first opening.

3. The reinforcing plate of claim 2, wherein the at least one pressure concentration surface further comprises a second pair of pressure concentration surfaces on opposite sides of the second opening.

4. The reinforcing plate of claim 3, wherein each of the first tab and the second tab further comprises:
an upper wall;
a lower wall; and
an outer sidewall.

5. The reinforcing plate of claim 4, wherein the first pair of pressure concentration surfaces comprises:
one pressure concentration surface in the first recess of the first tab; and
another pressure concentration surface on the lower wall of the first tab.

6. The reinforcing plate of claim 5, wherein the second pair of pressure concentration surfaces comprises:
one pressure concentration surface in the second recess of the second tab; and
another pressure concentration surface on the lower wall of the second tab.

7. The reinforcing plate of claim 1, wherein edges of the first and second recesses facing each other are open.

8. The reinforcing plate of claim 1, wherein the body is C-shaped.

9. A hinge assembly comprising:
a hinge comprising:
a cabinet mounting plate;
a cup mounting plate;
a hinge arm rotatably coupled to the cup mounting plate with a pin, and
a quick-release mechanism coupled to the hinge arm and configured to attach and detach from the cabinet mounting plate; and
a reinforcing plate comprising:
a body comprising:
a first tab;
a second tab connected to the first tab and spaced apart from the first tab;
a first opening in the first tab;
a second opening in the second tab;
a first recess in the first tab;
a second recess in the second tab; and
at least one pressure concentration surface at at least one of the first tab or the second tab,
wherein, when the reinforcing plate is coupled to the hinge, the cup mounting plate of the hinge is accommodated in the first recess and the second recess of the reinforcing plate and the at least one pressure concentration surface contacts a portion of the cup mounting plate in at least one of the first recess or the second recess.

10. The hinge assembly of claim 9, wherein the at least one pressure concentration surface comprises a first pair of pressure concentration surfaces on opposite sides of the first opening.

11. The hinge assembly of claim 10, wherein the at least one pressure concentration surface further comprises a second pair of pressure concentration surfaces on opposite sides of the second opening.

12. The hinge assembly of claim 11, wherein each of the first tab and the second tab further comprises:
an upper wall;
a lower wall; and
an outer sidewall.

13. The hinge assembly of claim 12, wherein the first pair of pressure concentration surfaces comprises:
one pressure concentration surface in the first recess of the first tab; and
another pressure concentration surface on the lower wall of the first tab.

14. The hinge assembly of claim 13, wherein the second pair of pressure concentration surfaces comprises:
one pressure concentration surface in the second recess of the second tab; and
another pressure concentration surface on the lower wall of the second tab.

15. The hinge assembly of claim 14, wherein edges of the first and second recesses facing each other are open.

16. The hinge assembly of claim 9, wherein the body is C-shaped.

17. A method of retrofitting a hinge to support a heavier load, the method comprising:
removing screws securing a cup mounting plate of the hinge to a cabinet door; and
attaching the reinforcing plate of claim 1 to the hinge and to the cabinet door with a plurality of screws.
